(19) United States
(12) Patent Application Publication
(10) Pub. No.: US 2012/0000867 A1
(43) Pub. Date: Jan. 5, 2012

(54) Expandable Shelf Display

(76) Inventor: Andrew R. Saving, Ooltewah, TN (US)

(21) Appl. No.: 12/829,677

(22) Filed: Jul. 2, 2010

(51) Int. Cl. A47F 1/04; G06K 19/06

(52) U.S. Cl. 211/59.2; 235/494

(57) ABSTRACT

An extendable shelf comprises a first shelf extension and a second shelf extension slidingly engaged to permit extension to a variety of widths. Stops mounted at predetermined locations to provide specific widths of the assembled shelf. An indicia sheet is carried by the first shelf extension. The indicia sheet is marked with a plurality of indicia to indicate the different potential widths of the assembled shelf. A cover sheet is carried by the second shelf extension. Lateral adjustment of the shelf extensions to different relative positions causes the cover sheet to exposes appropriate indicia to identify the current shelf width and covers the alternative indicia of widths.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to display rack shelves.

More particularly, this invention pertains to display rack shelves adapted for extension to a plurality of pre-defined positions and including indicia identifying the position of the rack shelf.

2. Description of the Related Art

In the field of display racks, for example the racks located in stores, such as grocery stores, the amount of space allocated for a display rack may vary based upon the location within the store and the time of year because some products are seasonal, for example. Accordingly, it is desirable to provide a rack which is adjustable in width to certain pre-determined widths, such 24 inches, 30 inches, 36 inches and 42 inches, etc.

It is also desirable to provide indicia to readily indicate the width of the rack so that representatives reviewing the racks can verify that the rack is occupying the allocated space.

### BRIEF SUMMARY OF THE INVENTION

According to one embodiment of the present invention, an extendable shelf adapted for mounting upon tubular leg supports comprises a first shelf extension and a second shelf extension slidingly engaged to permit extension to a variety of widths. Stops mounted at predetermined locations to provide specific widths of the assembled shelf. An indicia sheet is carried by the first shelf extension. The indicia sheet is marked with a plurality of indicia to indicate the different potential widths of the assembled shelf. A cover sheet is carried by the second shelf extension. Lateral adjustment of the shelf extensions to different relative positions causes the cover sheet to exposes appropriate indicia to identify the current shelf width and covers the alternative indicia of widths.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of an assembled shelf embodying various features of the present invention in a first position.

FIG. 2 is a perspective view of an assembled shelf embodying various features of the present invention in an extended position.

FIG. 3 is a perspective view of an indicia sheet embodying various features of the present invention.

FIG. 4 is a perspective view of a cover sheet embodying various features of the present invention.

FIG. 5 is an exploded perspective view of the shelf depicted in FIG. 1.

FIG. 6 is a bottom perspective view of the shelf depicted in FIG. 1.

FIG. 7 is a bottom perspective view of the shelf depicted in FIG. 2.

### DETAILED DESCRIPTION OF THE INVENTION

Referring to the drawings, in similar numbers identify similar parts, an adjustable width shelf apparatus is disclosed.

The shelf 10 comprises a first interior shelf extension 15 and a second interior shelf extension 20. The first shelf extension 15 includes two elongated shafts 25 and 30 and the second shelf extension 20 includes two elongated shafts 35 and 40. The elongated shafts 25, 30, 35 and 40 are adapted for sliding insertion within channels 45 and 50 mounted on opposing sides of the basket 55. An elongated central channel 58 is secured on the lower surface of the basket 55 and is adapted to slidingly receive a central extension 59 of the first interior shelf extension 15 and a central extension 61 of the second interior shelf extension 20 Apertures 70 are defined in the central extensions 59 and 61 at pre-defined intervals, such as 3 inches, for example. Two spring-mounted stop pins 60 and 65 are mounted upon the lower surface of the central channel for spring-loaded extension through the apertures 70.

A plurality of elongated crossbars 75 are adjustably mounted upon the elongated shafts 25 and 30 of the first interior shelf extension and upon the elongated shafts 35 and 40 of the second interior shelf extension 20. The crossbars 75 are movable between predetermined position s defined by grooves 80 defined in the elongated shafts 25, 30, 35 and 40. The crossbars 75 provide vertical support when the shelf is moved to an extended position.

Each of the first interior shelf extension 15 and the second shelf extension 20 include two opposed tubes 85 adapted for mounting upon tubular support legs as is well known in the art.

The first interior shelf extension 15 carries an indicia sheet 90. In the depicted embodiment, the indicia sheet 90 is secured to the first interior shelf extension 15 with screws 95 extending through the indicia sheet 90 and engaging apertures defined in the first interior shelf extension 15. Similarly, the second interior shelf extension 20 carries a cover sheet 100. In the depicted embodiment, the cover sheet 100 is secured to the second interior shelf extension 20 with screws 105 extending through the cover sheet and engaging apertures defined in the second interior shelf extension.

The indicia sheet 90 includes at least two sets of indicia 110 and 115. The indicia are preferably machine -readable, such as bar codes. The information provided by the indicia includes at least an indication of the current setting of the shelf extensions, but may also include information regarding the location of the rack, for example.

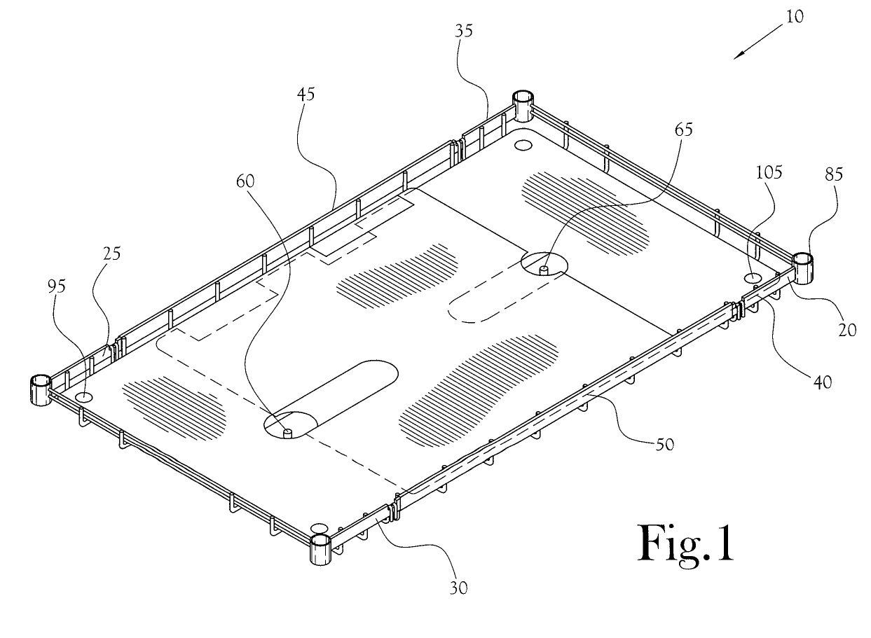

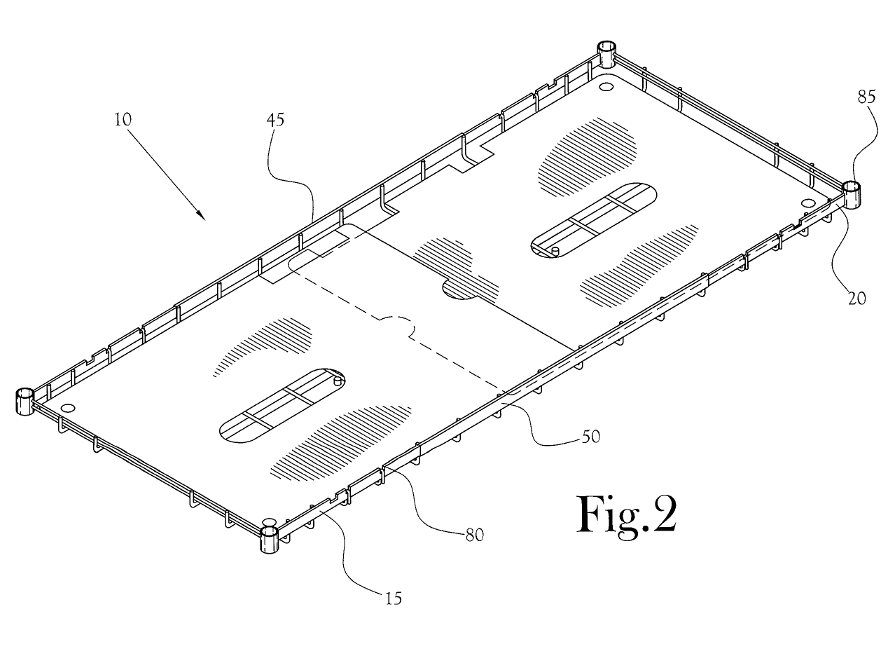

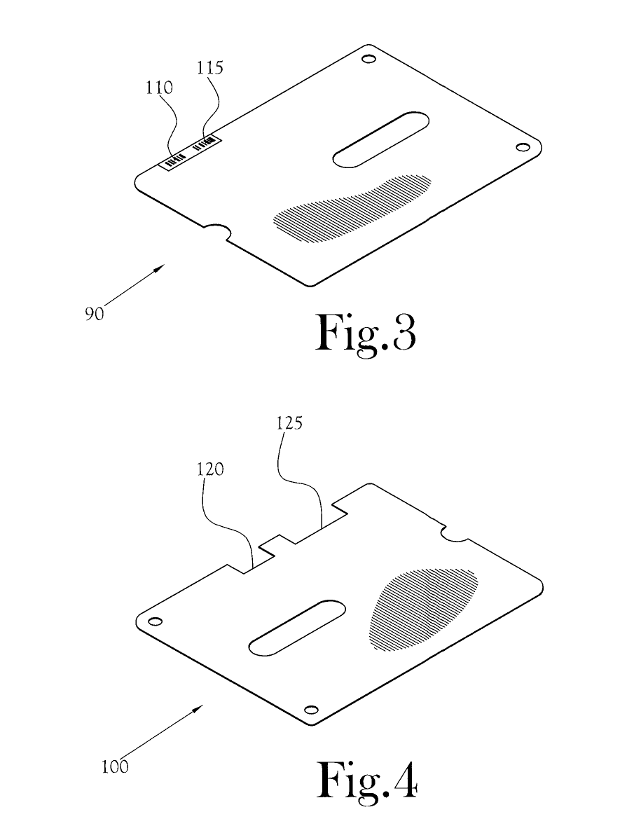

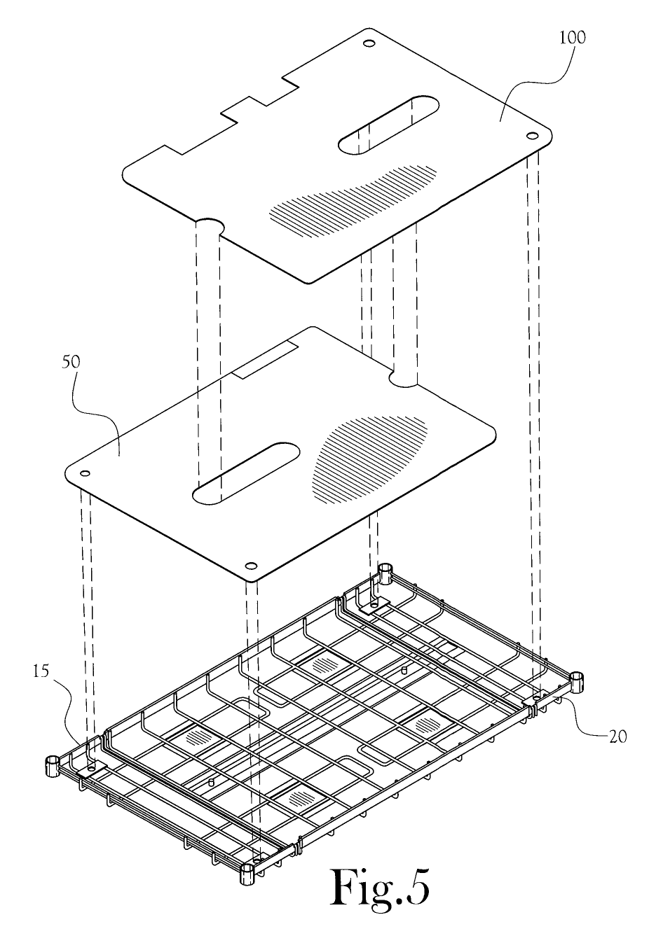

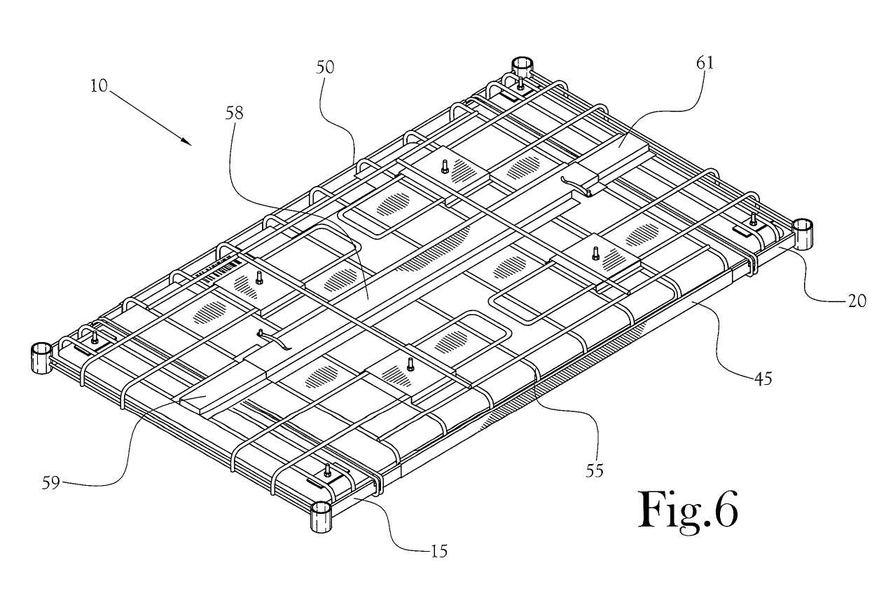

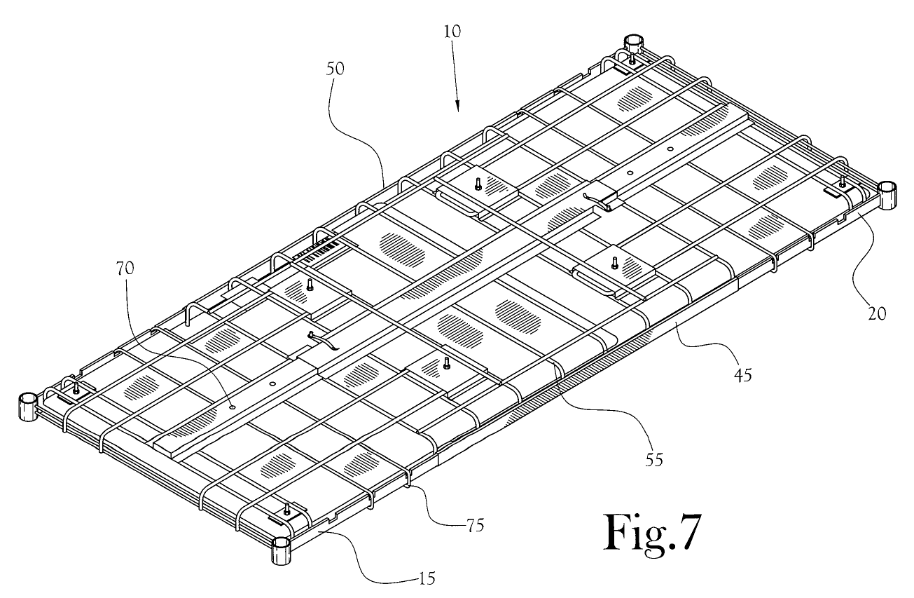

The cover sheet 100 is generally rectangular in shape, and defines two indents 120 and 125. The indents 120 and 125 are spaced apart so that when the shelf extension 15 and 20 are in a condensed position, as shown in FIGS. 1, 5 and 6, a first set of indicia is exposed through an indent and the second set of indicia is covered. When the shelf extensions 15 and 20 are in an extended position, as shown in FIGS. 2 and 7, the second set of indicia is exposed through an indent and the first set of indicia is covered.

In operation, at least one fully extended shelf 10 (and preferably a plurality of shelves 10) is mounted upon a set of support tubes in a fully extended position. In the fully extended position, one of the sets of indicia 110 or 115 is exposed through one of the indents 120 or 125. Thereby a scanner can read the indicia to determine the identity and location of the rack and the current width of the rack.

If the rack must be narrowed to a non-fully extended position, the spring loaded stops 60 are pushed out of the apertures 70 to allow the interior shelf extensions 15 and 20 to move toward one another in the channels 45, 50 and 58 until the spring-loaded stops engage alternative apertures 70. At that point the other of the indicia 110 or 115 is exposed through the other of the indents 120 or 125 so that a scanner can read the indicia to determine the identity and location and current width of the rack.

Those skilled in the art will recognize that a variety of indicia may be employed and that a plurality of positions may be accommodated through strategic positioning of the indicia and indents and that slots or other masking means may be employed to cover or expose the indicia without departing from the spirit and scope of the present invention. In addition, whereas the disclosed embodiment provides sliding engagement of two shelf extension through a central basket carrying channels, it will be recognized that one of the shelf extensions may carry one or more channels adapted to slidingly receive the shafts and extension of the other shelf extension.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An extendable shelf , said shelf comprising:
A first shelf extension and a second shelf extension slidingly engaged to permit extension to a variety of widths;
stops mounted at predetermined locations to provide specific widths of the assembled shelf;
an indicia sheet carried by said first shelf extension, said indicia sheet being marked with a plurality of indicia to indicate the different potential widths of the shelf;
a cover sheet carried by said second shelf extension;
whereby adjustment of said shelf extensions exposes an appropriate
whereby indication of the current shelf width and covers the alternative indicia of width.

2. The apparatus of claim 1 wherein said indicia comprise bar coding.

3. The apparatus of claim 1 wherein stop comprises a spring-loaded pin and an aperture.

4. The apparatus of claim 1 wherein at least one of said shelf extensions carries movable crossbars to provide vertical support when the shelf extensions are in an extended position.

5. The apparatus of claim 1 wherein said shelf extensions are slidingly engaged through a basket carrying channels.
